(19) United States
(12) Patent Application Publication
(10) Pub. No.: US 2016/0252657 A1
(43) Pub. Date: Sep. 1, 2016

(54) POLARIZER

(71) Applicant: BenQ Materials Corporation, Taoyuan City (TW)

(72) Inventors: Chen-Kuan KUO, New Taipei City (TW); Shih-Wei CHAO, Taoyuan City (TW); Ren-Hung HUANG, Taoyuan City (TW)

(21) Appl. No.: 14/936,693

(22) Filed: Nov. 10, 2015

(30) Foreign Application Priority Data
Feb. 26, 2015 (TW) 104106274

(51) Int. Cl. G02B 1/14; G02B 5/30

(52) U.S. Cl. CPC G02B 1/14; G02B 5/3025

(57) ABSTRACT

Disclosed herein is a polarizer for LCD. The polarizer includes a polarizing layer, a first protective layer and a second protective layer; which the second protective layer includes a plurality of quantum rods, and the major axis of the plurality of quantum rods is aligned in a direction perpendicular to the absorption axis of the polarizing layer. Accordingly, the incident unpolarized light emitted from the backlight unit can transfer to a polarized light by the plurality of quantum rods and pass through the polarizing layer directly for enhancing the utility of the backlight.

### RELATED APPLICATIONS

This application claims priority to Taiwanese Application Serial Number 104106274, filed on Feb. 26, 2015, which is herein incorporated by reference.

### FIELD OF THE INVENTION

This invention relates to a polarizer used in a liquid crystal display. Particularly, the invention relates to an integral polarizer containing a quantum rod layer for enhancing color gamut and light utilization of the liquid crystal display.

### BACKGROUND OF THE INVENTION

Polarizers commonly used in the liquid crystal display are absorptive polarizers. When, in a liquid crystal display, the non-polarized light emitted from the backlight is incident onto the absorptive polarizers, the incident light with a direction parallelly to the absorption axis direction of the polarizers is absorbed and not transmitted. Therefore, light emitted from backlight after passing through an absorptive polarizer will lose at least 50%. In addition, the light after passing through the polarizer will further pass through the electrode layer, color filter, liquid crystal module, glass substrate, and only about 10% of the light from the backlight is remained. Accordingly, the light utilization of the backlight is too low to waste energy.

Several approaches are provided to enhance the light utilization of the backlight, such as, for example the use of brightness enhancement film and/or prism film in backlight unit for continuously refracting and reflecting to recirculate and recycle the light which is unable to be transmitted by the polarizer to be redirected out of the backlight unit in order to enhance the light efficiency of the backlight. However, for minimizing to affect the viewing angle, it requires a combination of several brightness-enhancement films and prism films to achieve the expected result, which will increase the thickness of the backlight unit.

Another approach is provided a quantum rod layer integrated into the backlight unit. The quantum rod is a nano-scale semiconductor material. It is in a shape of a one-dimensional rod-like structure. The major axis direction of the quantum rod is able to absorb the non-polarized Light to emit a polarized light with a wavelength longer than the original non-polarized light. Because of the high internal quantum efficiency, a major of the incident light from the backlight source is polarized. The quantum rods are aligned in the direction of major axis, and the emitted polarized light is efficiently passed through the transmission axis of the polarizer disposed on the liquid crystal display. Accordingly, compared to the traditional backlight unit, the light utilization of a backlight unit with the quantum rod layer will be enhanced. However, the semiconductor material of the quantum rods is susceptible to be adversely affected by oxygen and moisture in ambient environment to result in decreased durability thereof. It is proposed in the related art that the quantum rod layer is needed to be further packaged for isolating from the ambient environment. The thickness of the backlight unit will thus be increased. Furthermore, because the quantum rod layer is disposed in the backlight unit and is close to the light source, the heat generated from the light source will cause the heal fading of the quantum rods to decrease the fluorescent efficiency thereof, if no heat dissipation or insulation device is provided to the quantum rod layer. In addition, in a backlight unit with a quantum rod layer, the light from the backlight will pass through a plurality of optical films, such as the light guide film, diffuser film, bright enhancement film, multiple prism sheet and/or outer protective film of the polarizer, the emitted polarized light from the quantum rod layer will he reflected and refracted between the optical films. Thus, the polarization and directionality of the polarized light from the quantum rod layer is decreased. The light intensity which will pass through the polarizer under the liquid crystal cell is lowered than expected. In case of that a single quantum rod film is arranged with a backlight to be a polarized light source without any other optical films, such as a variety of optical functional films or polarizer, the polarization efficiency of the polarized light of backlight is still insufficient. This is because, although the transmission of the light from backlight source through a quantum rod layer is more 50% than that through a single polarizer, the polarized light will be generated in both the major axis direction and the minor axis direction of the quantum rods, the quantum rod layer does not obtain a polarization the same as to the current polarizers with 99% of polarization to meet the commercial requirements of contrast ratio and color saturation for liquid crystal displays.

Therefore, the present invention discloses an integral polarizer which obtains a better light utilization of the current liquid crystal display without any modification of the current backlight module used therein.

### SUMMARY OF THE INVENTION

In view of the above problems of the prior art, it is provided a novel, inventive and useful polarizer. The present polarizer includes a polarizing layer and a quantum rod layer. The quantum rod layer of the present polarizer enhances the luminous intensity transmitted into the polarizing layer thereof and, accordingly, the polarizing layer transmits out intensively polarized light. Furthermore, the protective layer for the present polarizer can be used as a barrier layer to the quantum rod layer. Therefore, when the present polarizer is used in the current liquid crystal display, the thickness of the backlight unit and/or the liquid crystal display will not increase. In addition, the present polarizer is not disposed in the backlight unit, and the present polarizer will not be affected by the heat generated from the light source. Therefore, the disadvantages arose in the state of art will be eliminated.

In an aspect of the present invention, there is provided an integral polarizer. In a preferred embodiment of the present invention, the polarizer includes a polarizing layer having an absorption axis; a first protective layer disposed on a surface of the polarizing layer; and a second protective layer disposed on the other surface of the polarizing layer, the second protective layer including a plurality of quantum rods, and major axis of the quantum rods is aligned in a direction perpendicular to the absorption axis of the polarizing layer and parallel to the transmission axis of the polarizing layer.

In a preferred embodiment of the polarizer of the present invention, the second protective layer is a light incidence side of an incident light, and the first protective layer is a light exiting side.

In another preferred embodiment of the polarizer of the present invention, a wavelength of the incident light is in a range from 300 nm to 495 nm to excite the quantum rod layer.

In further a preferred embodiment of the present invention, a semiconductor material of the quantum rods is a compound selected from the group consisting of Group III-V, Group II-VI, Group IV-VI and combinations thereof.

In still a preferred embodiment of the present invention, the polarizing layer of the present polarizer can be an absorptive polarizing layer, a reflective polarizing layer, dye-type polarizing layer, coating-type polarizing layer, wire-grid polarizing layer or combinations thereof.

In further another preferred embodiment of the present invention, the quantum rods are dispersed in a polymer to form the second protective layer.

In further still a preferred embodiment of the present invention, the material for the first protective layer and the second protective layer includes cellulose triacetate, polyethylene terephthalate, polymethyl methacrylate, cyclo-olefin polymer, polysiloxanes or metal oxide-containing organic/inorganic composite film.

In a preferred embodiment of the present invention, the first protective layer is an optical compensation film.

In an embodiment of the present invention, further comprising an encapsulating layer disposed between the first protective layer and the polarizing layer or between the second protective layer and polarizing layer, respectively. The encapsulating layer includes polymethyl methacrylate, epoxy resin, polysiloxanes, fluororesin polymer or copolymer.

### DESCRIPTION OF THE DRAWINGS

The invention can be more fully understood by reading the following detailed description of the embodiment, with reference made to the accompanying drawings that illustrate the invention and it should be noted that the drawings are not to scale and only for illustration only.

FIGS. 1a and 1b show perspective views of an exemplary embodiment of the present invention.

### DETAILED DESCRIPTION OF THE INVENTION

The polarizers disclosed in the present invention are set forth in the appended claims. Objectives, advantages, and a preferred mode of making and using the polarizers may be understood best, by reference to the following detailed description in conjunction with the accompanying drawings. The description provides information that enables a person skilled in the art to make and use the claimed subject matter, but may omit certain details already well-known in the art. The following detailed description is, therefore, not to be taken in a limiting sense, and the scope of the illustrative embodiments are defined only by the appended claims.

The polarizers of the present invention will now be described in reference to the accompanying drawings. Similar numbers on the drawings refers to the same elements.

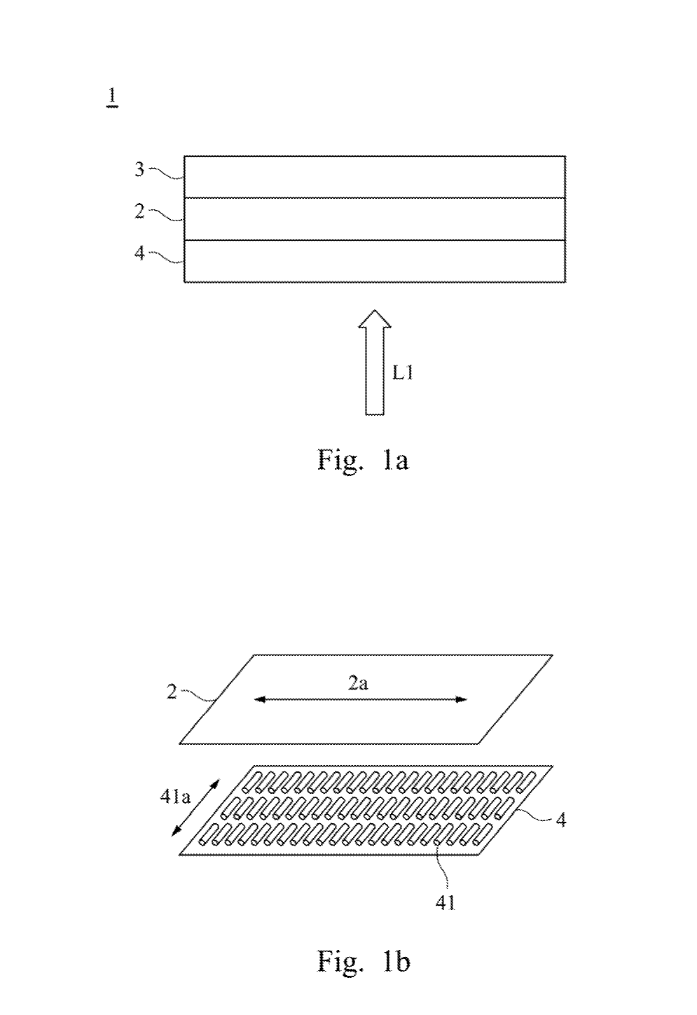

FIGS. 1a and 1b show the perspective views of the polarizer 1 of a preferred exemplary embodiment of the present invention. The polarizer 1 includes a polarizing layer 2 with absorption axis 2a; a first protective layer 3 disposed on one side of the polarizing layer 2; and a second protective layer 4 disposed on the other side of the polarizing layer 2 and including a plurality of quantum rods 41, which the major axis 41a of the quantum rods 41 is aligned in a direction perpendicular to the absorption axis 2a of the polarizing layer 2.

In an embodiment of a polarizer of the present invention, light L1 is incident to the second protective layer 4 and passes through out from the first protective layer 3. Therefore, the unpolarized incident light L1 is transferred by the quantum rods 413 to a polarized light with a polarizing axis perpendicular to the direction of the absorption axis 2a of the polarizing layer 2. The polarized light passes through the direction of the transmission axis of the polarizing layer 2.

In a polarizer of another exemplary embodiment of the present invention, the wavelength of the incident light is in a wavelength range between ultraviolet ray and blue light, preferably between 300 nm to 495 nm. The light incident to the second protective layer, which the quantum rods in said layer are excited to emit a light with a longer wavelength. Further, the color of the light emitted from the quantum rods can be adjusted by changing the size of the quantum rods in the said layer. For example, CdSe quantum rods with a major axis of 30 nm to 40 nm and a minor axis of the 5 nm to 10 nm will emit a red light of wavelength 630 nm under a blue light source of wavelength 460 nm. When the CdSe quantum rods with a major axis of 20 nm to 30 nm and a minor axis of the 2 nm to 5 nm will emit a green light of wavelength 550 nm under a blue light source. Thus, by adjusting ratio of the content of quantum rods with different sizes in the second protective layer, the light from the quantum rods, which is mixed with the green light and the red light respectively emitted from the quantum rods with different sizes, together with the transmitted blue light from the light source will be adjusted to be the desired white light source for displays. In addition, because the excitation spectrum of the quantum rods material is with a narrow full-width-at-half-maximum (FWHM), the gamut area of the display using the present polarizer will be larger.

In an embodiment of the present invention, the semiconductor material of the quantum rods is a material selected from the group consisted of Group III-V, Group II-VI Group IV-VI and the combination thereof. The semiconductor material can include but not limit to AlN, AlP, AlAs, AlSb, GaN, GaP, GaAs, GaSb, InN, InP, InSb, ZnO, ZnS, ZnSe, ZnTe, CdS, CdSe, CdTe, HgSe, HgTe, PbS, PbSe or PbTe.

In an embodiment of the present invention, the polarizing layer of the present polarizer can be selected in accordance with the use of the display, for example, an absorptive polarizing layer, a reflective polarizing layer, dye-type polarizing layer, coating-type polarizing layer. wire-grid polarizing layer or the combination thereof.

In an embodiment of the present invention, the quantum rods are uniformly dispersed in an uncured polymer for forming the second protective layer. The uncured polymer can be in a molten phase or in a form of a polymer solution and is further extruded or casting for forming a film. The quantum rods, before the film is completely cured, can be aligned by electric field driving, stretching, rubbing and the like in the direction of the major axis thereof. Then, the polymer film is thermo- or photo-cured to form a layer of second protective layer. The polymer used for forming both the first and second protective layers includes cellulose triacetate, polyethylene terephthalate, polymethyl methacrylate, cyelo-olefin polymer, polysiloxanes or metal oxide-containing organic/inorganic composite film.

In an embodiment of the present invention, the first protective layer is an optical compensation film, such as, for example for improving the viewing angle or the color-shift.

In an embodiment of the present invention, an encapsulating layer is optionally provided between the first protective layer and polarizing layer, and the second protective layer and the quantum rod layer, respectively, to protect the quantum rod layer from moisture, oxygen in the environment for extending the life of the quantum rod layer. The encapsulating layer includes polymethyl methacrylate, epoxy resin, polysiloxanes, fluororesin polymer or copolymer.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A polarizer comprising:
a polarizing layer having an absorption axis;
a first protective layer disposed on a surface of the polarizing layer; and
a second protective layer disposed on the other surface of the polarizing layer, the second protective layer comprising a plurality of quantum rods, and major axis of the quantum rods is aligned in a direction perpendicular to the absorption axis of the polarizing layer.

2. The polarizer of claim 1, wherein the second protective layer is a light incidence side of an incident light, and the first protective layer is a light exiting side.

3. The polarizer of claim 2, wherein a wave length of the incident light is in a range from 300 nm to 495 nm to excite the quantum rods of the second protective layer.

4. The polarizer of claim 1, wherein a semiconductor material of the quantum rods is a compound selected from the group consisting of Group III-V, Group II-VI, Group IV-VI and combinations thereof.

5. The polarizer of claim 1, wherein the polarizing layer is an absorptive polarizing layer, a reflective polarizing layer, dye-type polarizing layer, coating-type polarizing layer, wire-grid polarizing layer or combinations thereof.

6. The polarizer of claim 1, wherein the quantum rods are dispersed in the second protective layer.

7. The polarizer of claim 1, wherein the first protective layer and the second protective layer comprises cellulose triacetate, polyethylene terephthalate, polymethyl methacrylate, cyclo-olefin polymer, polysiloxanes or metal oxide-containing organic/inorganic composite film.

8. The polarizer of claim 1, wherein the first protective layer is an optical compensation film.

9. The polarizer of claim 1, further comprising an encapsulating layer disposed between the first protective layer and the polarizing layer or between the polarizing layer and the second protective layer.

10. The polarizer of claim 9, wherein the encapsulating layer comprises polymethyl methacrylate, epoxy resin, polysiloxanes, fluororesin polymer or copolymer.
